(19) United States
(12) Patent Application Publication
(10) Pub. No.: US 2025/0310766 A1
(43) Pub. Date: Oct. 2, 2025

(54) AUTHENTICATION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Zhengyi SHANG, Beijing (CN); Wei LU, Beijing (CN)

(73) Assignee: Beijing Xiaomi Mobile Software Co., Ltd., Beijing (CN)

(21) Appl. No.: 18/865,177

(22) PCT Filed: May 13, 2022
(86) PCT No.: PCT/CN2022/092893

§ 371 Date: Nov. 12, 2024

(51) Int. Cl. H04W 12/069

(52) U.S. Cl. CPC H04W 12/069

(57) ABSTRACT

Provided in the embodiments of the present disclosure is an authentication method. The method is executed by a first root certificate authority (CA), and comprises: generating a first type of certificate on the basis of a transport layer security (TLS) protocol, wherein the first type of certificate is a certificate of an entity in a first security domain where the first root CA is located.

### CROSS-REFERENCE TO RELATED APPLICATIONS

This application is a national stage of International Application No. PCT/CN2022/092893, filed on May 13, 2022, which is hereby incorporated by reference in its entirety.

### TECHNICAL FIELD

The present disclosure relates to, but is not limited to, the field of wireless communication technologies, and in particular, to an authentication method and apparatus, a communication device, and a storage medium.

### BACKGROUND

The use of Transport Layer Security (TLS) protocol in Service Based Architecture (SBA) of 5G (5th Generation Mobile Communication Technology) is ubiquitous. However, unlike standardized model using Certificate Management Protocol v2 (CMPv2) in wireless networks, SBA does not have a standardized model and set of procedures for automated certificate management. SBA also does not have a standardized protocol for managing life cycle events of the certificates. Therefore, automated certificate management in the SBA architecture needs to be studied.

### SUMMARY

Embodiments of the present disclosure provides an authentication method and apparatus, a communication device and a storage medium.

According to a first aspect of the embodiments of the present disclosure, an authentication method is provided, performed by a first root certificate authority (CA), where the method includes:

generating a first-type certificate based on a transport layer security (TLS) protocol;

where the first-type certificate is a certificate of an entity in a first security domain in which the first root CA is located.

In an embodiment, the method further includes:

sending the first-type certificate to the entity.

In an embodiment, generating the first-type certificate based on a transport layer security (TLS) protocol includes:

generating the first-type certificate signed based on a private key of the first root CA.

In an embodiment, generating the first-type certificate based on a transport layer security (TLS) protocol includes:

generating a root certificate;

where the root certificate is used to generate the first-type certificate.

In an embodiment, the entity includes at least one of:

Root CA;

TLS server CA;

TLS client CA;

TLS proxy CA;

Interconnection CA;

TLS server;

TLS client; or

TLS proxy.

According to a second aspect of the embodiments of the present disclosure, an authentication method is provided, performed by an interconnection certificate authority (CA) in a first security domain in which a first root CA is located, where the method includes:

generating a second-type certificate based on a transport layer security (TLS) protocol;

where the second-type certificate is a certificate of an entity in a second security domain in which a second root CA is located, and the second-type certificate is at least used for TLS verification between entities in the first security domain and the second security domain.

In an embodiment, the entity includes at least one of:

TLS proxy CA;

TLS proxy;

TLS server; or

TLS client.

In an embodiment, generating a second-type certificate based on a transport layer security (TLS) protocol includes:

generating a TLS proxy CA certificate of a TLS proxy CA signed based on a private key of the interconnection CA.

In an embodiment, the method further includes:

sending the second-type certificate to the entity.

According to a third aspect of the embodiments of the present disclosure, an authentication method is provided, performed by a first-type entity, where the method includes:

acquiring a predetermined certificate, where the predetermined certificate includes at least one of: the first-type certificate of entities in the first security domain in which the first root CA is located; and a second-type certificate of entities in a second security domain in which a second root CA is located, where the second-type certificate is at least used for TLS verification between entities in the first security domain and the second security domain.

In an embodiment, acquiring the predetermined certificate includes:

acquiring the predetermined certificate that is pre-configured; or,

receiving the predetermined certificate sent by the first root CA or the interconnection CA.

In an embodiment, the first-type entity includes at least one of:

TLS server CA;

TLS client CA; or

TLS proxy CA.

In an embodiment, the method further includes:

generating a third-type certificate signed based on a private key of the first-type entity.

In an embodiment, the method further includes:

sending a third-type certificate to a second-type entity, where the third-type certificate includes a public key used to establish a TLS tunnel between different entities.

In an embodiment, the first-type entity includes a TLS client CA; the second-type entity includes a TLS client; and sending the third-type certificate to the second-type entity includes: sending a TLS client certificate to the TLS client.

In an embodiment, the first-type entity includes a TLS server CA; the second-type entity includes a TLS server; and sending the third-type certificate to the second-type entity includes: sending a TLS server certificate to the TLS server.

In an embodiment, the first-type entity includes a TLS proxy CA; the second-type entity includes a TLS proxy; and sending the third-type certificate to the second-type entity includes: sending a TLS proxy certificate to the TLS proxy.

In an embodiment, sending the third-type certificate to the second-type entity includes: sending a TLS client certificate and a TLS server certificate to the second-type entity.

In an embodiment, the second-type entity includes at least one of:

TLS server;

TLS client; or

TLS proxy.

According to a fourth aspect of the embodiments of the present disclosure, an authentication method is provided, performed by a second-type entity, where the method includes:

acquiring a third-type certificate, where the third-type certificate includes a public key used to establish a transport layer security (TLS) tunnel between different entities. In an embodiment, acquiring the third-type certificate includes:

acquiring the third-type certificate that is pre-configured;

or,

receiving the third-type certificate sent by the first-type entity.

In an embodiment, the first-type entity includes at least one of:

TLS server CA;

TLS client CA; or

TLS proxy CA.

In an embodiment, the second-type entity includes at least one of:

TLS server;

TLS client; or

TLS proxy.

In an embodiment, the first-type entity includes a TLS client CA; the second-type entity includes a TLS client; and acquiring the third-type certificate includes:

receiving a TLS client certificate sent by the TLS client CA.

In an embodiment, the first-type entity includes a TLS server CA; the second-type entity includes a TLS server; and acquiring the third-type certificate includes:

receiving a TLS server certificate sent by the TLS server CA.

In an embodiment, the first-type entity includes a TLS proxy CA; the second-type entity includes a TLS proxy; and acquiring the third-type certificate includes: receiving a TLS proxy certificate sent by the TLS proxy CA.

In an embodiment, acquiring the third-type certificate includes:

receiving a TLS client certificate and a TLS server certificate sent by a first-type entity.

According to a fifth aspect of the embodiments of the present disclosure, an authentication method is provided, performed by a transport layer security (TLS) client, where the method includes:

determining whether a TLS server certificate is trusted in response to receiving the TLS server certificate of a TLS server;

where the TLS server and a TLS client are within a same security domain.

In an embodiment, determining whether the TLS server certificate is trusted includes:

verifying whether the TLS server certificate is trusted based on a TLS server certificate authority (CA) certificate.

In an embodiment, the method further includes:

verifying whether the TLS server CA certificate is trusted based on a root certificate in a security domain.

According to a sixth aspect of the embodiments of the present disclosure, an authentication method is provided, performed by a first transport layer security (TLS) proxy, where the method includes:

determining whether a second TLS proxy certificate is trusted in response to receiving the second TLS proxy certificate sent by a second TLS proxy in a second security domain.

In an embodiment, determining whether the second TLS proxy certificate is trusted includes:

verifying whether the second TLS proxy certificate is trusted based on a TLS proxy certificate authority (CA) certificate in the second security domain.

In an embodiment, the method further includes:

verifying whether the TLS proxy CA certificate is trusted based on an interconnection CA certificate in the first security domain.

In an embodiment, the method further includes:

verifying whether the interconnection CA certificate in the first security domain is trusted based on a root certificate in the first security domain.

According to a seventh aspect of the embodiments of the present disclosure, an authentication method is provided, performed by a first transport layer security (TLS) proxy, where the method includes:

determining whether a TLS client certificate is trusted in response to receiving the TLS client certificate sent by a TLS client in the first security domain.

In an embodiment, determining whether the TLS client certificate is trusted includes:

verifying whether the TLS client certificate is trusted based on a TLS client CA certificate in the first security domain.

In an embodiment, the method further includes:

verifying whether the TLS client CA certificate is trusted based on a root certificate in the first security domain.

According to an eighth aspect of the embodiments of the present disclosure, an authentication method is provided, performed by a first transport layer security (TLS) proxy, where the method includes:

determining whether a TLS server certificate is trusted in response to receiving the TLS server certificate sent by a TLS server in the first security domain.

In an embodiment, determining whether the TLS server certificate is trusted includes:

verifying whether the TLS server certificate is trusted based on a TLS server CA certificate in the first security domain.

In an embodiment, the method further includes:

verifying whether the TLS server CA certificate is trusted based on a root certificate in the first security domain.

According to a ninth aspect of the embodiments of the present disclosure, an authentication apparatus is provided, where the apparatus includes:

a generating module, configured to generate a first-type certificate based on a transport layer security (TLS) protocol;

where the first-type certificate is a certificate of an entity in a first security domain in which the first root CA is located.

According to a tenth aspect of the embodiments of the present disclosure, an authentication apparatus is provided, where the apparatus includes:

a generating module, configured to generate a second-type certificate based on a transport layer security (TLS) protocol;

where the second-type certificate is a certificate of an entity in a second security domain in which a second root CA is located, and the second-type certificate is at least used for TLS verification between entities in the first security domain and the second security domain.

According to an eleventh aspect of the embodiments of the present disclosure, an authentication apparatus is provided, where the apparatus includes:

a receiving module, configured to receive a first-type certificate based on a transport layer security (TLS) protocol, where the first-type certificate is a certificate of an entity in a first security domain in which a first root certificate authority (CA) is located.

According to a twelfth aspect of the embodiments of the present disclosure, an authentication apparatus is provided, where the apparatus includes:

a receiving module, configured to acquire a third-type certificate, where the third-type certificate includes a public key used to establish a transport layer security (TLS) tunnel between different entities.

According to a thirteen aspect of the embodiments of the present disclosure, an authentication apparatus is provided, where the apparatus includes:

a determining module, configured to determine whether a transport layer security (TLS) server certificate is trusted in response to receiving the TLS server certificate of a TLS server;

where the TLS server and a TLS client are within a same security domain.

According to a fourteenth aspect of the embodiments of the present disclosure, an authentication apparatus is provided, where the apparatus includes:

a determining module, configured to determine whether a second transport layer security (TLS) proxy certificate is trusted in response to receiving the second TLS proxy certificate sent by a second TLS proxy in a second security domain.

According to a fifteenth aspect of the embodiments of the present disclosure, an authentication apparatus is provided, where the apparatus includes:

a determining module, configured to determine whether a transport layer security (TLS) client certificate is trusted in response to receiving the TLS client certificate sent by a TLS client in a first security domain.

According to a sixteenth aspect of the embodiments of the present disclosure, an authentication apparatus is provided, where the apparatus includes:

a determining module, configured to determine whether a transport layer security (TLS) server certificate is trusted in response to receiving the TLS server certificate sent by a TLS server in a first security domain.

According to a seventeenth aspect of the embodiments of the present disclosure, a communication device is provided, where the communication device includes:

a processor; and

a memory for storing a processor-executable instruction;

the processor is configured to execute the executable instruction to implement the method according to any one embodiment of the present disclosure.

According to an eighteenth aspect of the embodiments of the present disclosure, a computer storage medium is provided, where the computer storage medium stores a computer-executable program, and when the executable program is executed by a processor, the method according to any one embodiment of the present disclosure is implemented.

In the embodiments of the present disclosure, the first-type certificate based on the Transport Layer Security (TLS) protocol is generated, where the first-type certificate is a certificate of entities in a first security domain in which a first root CA is located. In this way, because the first root certificate authority (CA) can generate the first-type certificate, entities in a same security domain can implement authentication between entities based on the first-type certificate. Compared with a situation without intra-domain entity authentication, the authentication mechanism of the wireless communication network is improved, and the authentication reliability of the wireless communication network is improved.

### BRIEF DESCRIPTION OF DRAWINGS

FIG. 1 is a schematic structural diagram of a wireless communication system according to an example embodiment.

FIG. 2 is a schematic flowchart of an authentication method according to an example embodiment.

FIG. 3 is a schematic diagram of an SBA architecture according to an example embodiment.

FIG. 4 is a schematic diagram of a chain of trust according to an example embodiment.

FIG. 5 is a schematic diagram of a chain of trust according to an example embodiment.

FIG. 6 is a schematic flowchart of an authentication method according to an example embodiment.

FIG. 7 is a schematic flowchart of an authentication method according to an example embodiment.

FIG. 8 is a schematic flowchart of an authentication method according to an example embodiment.

FIG. 9 is a schematic flowchart of an authentication method according to an example embodiment.

FIG. 10 is a schematic flowchart of an authentication method according to an example embodiment.

FIG. 11 is a schematic flowchart of an authentication method according to an example embodiment.

FIG. 12 is a schematic flowchart of an authentication method according to an example embodiment.

FIG. 13 is a schematic flowchart of an authentication method according to an example embodiment.

FIG. 14 is a schematic flowchart of an authentication method according to an example embodiment.

FIG. 15 is a schematic flowchart of an authentication method according to an example embodiment.

FIG. 16 is a schematic flowchart of an authentication method according to an example embodiment.

FIG. 17 is a schematic flowchart of an authentication method according to an example embodiment.

FIG. 18 is a schematic flowchart of an authentication method according to an example embodiment.

FIG. 19 is a schematic flowchart of an authentication method according to an example embodiment.

FIG. 20 is a schematic flowchart of an authentication method according to an example embodiment.

FIG. 21 is a schematic flowchart of an authentication method according to an example embodiment.

FIG. 22 is a schematic flowchart of an authentication method according to an example embodiment.

FIG. 23 is a schematic flowchart of an authentication method according to an example embodiment.

FIG. 24 is a schematic flowchart of an authentication method according to an example embodiment.

FIG. 25 is a schematic flowchart of an authentication method according to an example embodiment.

FIG. 26 is a schematic flowchart of an authentication method according to an example embodiment.

FIG. 27 is a schematic flowchart of an authentication method according to an example embodiment.

FIG. 28 is a schematic flowchart of an authentication method according to an example embodiment.

FIG. 29 is a schematic flowchart of an authentication method according to an example embodiment.

FIG. 30 is a schematic flowchart of an authentication method according to an example embodiment.

FIG. 31 is a schematic flowchart of an authentication method according to an example embodiment.

FIG. 32 is a schematic flowchart of an authentication method according to an example embodiment.

FIG. 33 is a schematic diagram of an authentication apparatus according to an example embodiment.

FIG. 34 is a schematic diagram of an authentication apparatus according to an example embodiment.

FIG. 35 is a schematic diagram of an authentication apparatus according to an example embodiment.

FIG. 36 is a schematic diagram of an authentication apparatus according to an example embodiment.

FIG. 37 is a schematic diagram of an authentication apparatus according to an example embodiment.

FIG. 38 is a schematic diagram of an authentication apparatus according to an example embodiment.

FIG. 39 is a schematic diagram of an authentication apparatus according to an example embodiment.

FIG. 40 is a schematic diagram of an authentication apparatus according to an example embodiment.

FIG. 41 is a schematic structural diagram of a terminal according to an example embodiment.

FIG. 42 is a block diagram of a base station according to an example embodiment.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. Implementations described in the following example embodiments do not represent all implementations consistent with the embodiments of the present disclosure. Rather, they are merely examples of apparatuses and methods consistent with some aspects of embodiments of the present disclosure as detailed in the appended claims.

The terminologies used in the embodiments of the present disclosure are merely for the purpose of describing specific embodiments, and are not intended to limit the embodiments of the present disclosure. Singular forms “a” and “the” used in the embodiments of the present disclosure and the appended claims are also intended to include plural forms unless the context clearly indicates other meanings. It should also be understood that the term “and/or” as used herein refers to and encompasses any or all possible combinations of one or more associated listed items.

It should be understood that although the terms “first”, “second”, “third”, etc., may be used to describe various information in the embodiments of the present disclosure, these information should not be limited to these terms. These terms are only used to distinguish a same type of information from each other. For example, without departing from the scope of the embodiments of the present disclosure, “first information” may also be referred to as “second information”, and similarly, “second information” may also be referred to as “first information”. Depending on context, word “if” as used herein may be interpreted as “when” or “upon” or “in response to determining”.

For purposes of brevity and ease of understanding, terms “greater than” or “less than” are used herein in characterizing a size relationship. However, those skilled in the art may understand that the term “greater than” also covers the meaning of “greater than or equal to”, and “less than” also covers the meaning of “less than or equal to”.

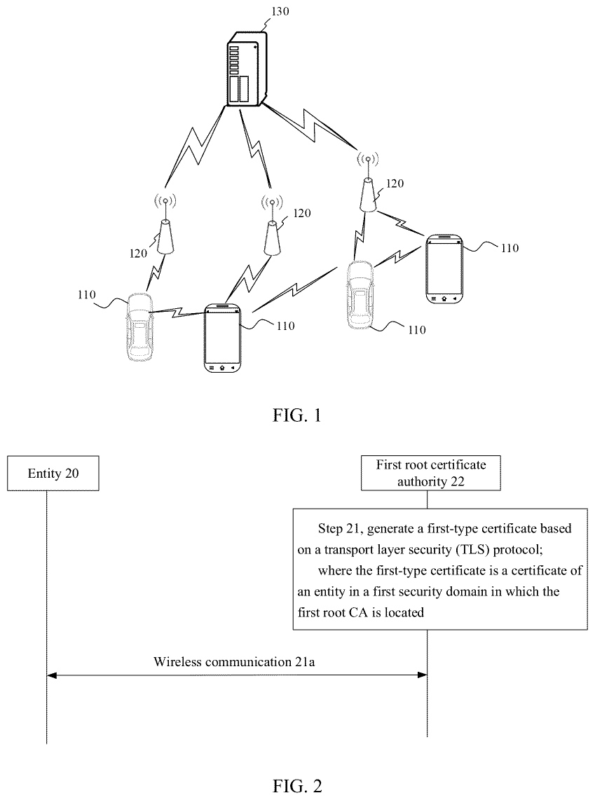

FIG. 1 is a schematic structural diagram of a wireless communication system according to an embodiment of the present disclosure. As shown in FIG. 1, a wireless communication system is a communication system based on a mobile communication technology, and the wireless communication system may include: several user equipments 110 and several base stations 120.

The user equipment 110 may be a device that provides voice and/or data connectivity to a user. The user equipment 110 may communicate with one or more core networks through a radio access network (RAN), and the user equipment 110 may be Internet of Things user equipment, such as a sensor device, a mobile phone, and a computer having the Internet of Things user equipment, for example, may be a fixed, portable, pocket, handheld, computer built-in, or in-vehicle apparatus. For example, a station (STA), a subscriber unit, a subscriber station, a mobile station, a mobile, a remote station, an access point, a remote terminal, an access terminal, a user terminal, a user agent, a user device, or a user equipment. Alternatively, the user equipment 110 may be a device of an unmanned aerial vehicle. Alternatively, the user equipment 110 may be an in-vehicle device, for example, may be a vehicle computer having a wireless communication function, or a wireless user equipment externally connected to a vehicle computer. Alternatively, the user equipment 110 may be a roadside device, for example, a street lamp, a signal light, or other roadside devices having a wireless communication function.

The base station 120 may be a network-side device in a wireless communication system. The wireless communication system may be a 4th generation mobile communication (4G) system, also referred to as a long term evolution (LTE) system; or the wireless communication system may be a 5G system, also referred to as a new radio (NR) system or a 5G NR system. Alternatively, the wireless communication system may be a next generation system of the 5G system. An access network in the 5G system may be referred to as a new generation-radio access network (NG-RAN).

The base station 120 may be an evolved NodeB (eNB) used in the 4G system. Alternatively, the base station 120 may be a base station in a centralized distributed architecture in the 5G system (gNB). When the base station 120 adopts a centralized distributed architecture, the base station 120 usually includes a central unit (CU) and at least two distributed units (DU). The central unit is provided with a protocol stack of a Packet Data Convergence Protocol (PDCP) layer, a Radio Link Control (RLC) layer, and a Media Access Control (MAC) layer; and the distributed unit is provided with a protocol stack of a Physical (PHY) layer, which is not limited in the embodiments of the present disclosure.

A wireless connection may be established between the base station 120 and the user equipment 110 through a wireless air interface. In different implementations, the wireless air interface is a wireless air interface based on a fourth generation mobile communication network technology (4G) standard; or the wireless air interface is a wireless air interface based on a fifth generation mobile communication network technology (5G) standard, for example, the wireless air interface is a new air interface; or the wireless air interface may also be a wireless air interface based on a next generation mobile communication network technology standard of 5G.

In some embodiments, an E2E (End to End) connection may also be established between the user equipments 110. For example, scenarios such as V2V (vehicle to vehicle) communication, V2I (vehicle to infrastructure) communication, and V2P (vehicle to peer) communication in V2X (vehicle to vehicle) communication.

Herein the user equipment may be considered as a terminal device in the following embodiments.

In some embodiments, the wireless communication system may further include a network management device 130.

The base stations 120 are respectively connected to a network management device 130. The network management device 130 may be a core network device in a wireless communication system, for example, the network management device 130 may be a mobility management entity (MME) in an evolved packet core (EPC) network. Alternatively, the network management device may be other core network devices, for example, a serving gateway (SGW), a public data network gateway (PGW), a policy and charging rules function (PCRF), or a home subscriber server (HSS). An implementation form of the network management device 130 is not limited in the embodiments of the present disclosure.

For ease of understanding by those skilled in the art, the embodiments of the present disclosure list a plurality of implementations to clearly describe the technical solutions of the embodiments of the present disclosure. Certainly, those skilled in the art may understand that the multiple embodiments provided by the embodiments of the present disclosure may be executed separately, or may be executed together with the methods of other embodiments in the embodiments of the present disclosure, or may be executed separately or in combination with some methods in other related technologies; the embodiments of the present disclosure are not limited thereto.

In order to better understand the technical solutions described in any one embodiment of the present disclosure, application scenarios in the related art are described first.

The use of transport layer security (TLS) certificate in service based architecture (SBA) of 5G (5th Generation Mobile Communication Technology) is ubiquitous. Certificate-based Internet Protocol will be used to protect non-variable bandwidth chip interconnect (scaleable bandwidth interconnect, SBI) interfaces, for example, N4 interface or N9 interface. However, unlike standardized model using Certificate Management Protocol v2 (CMPv2) in wireless networks, SBA does not have a standardized model and set of procedures for automated certificate management.

SBA also does not have a standardized protocol for managing life cycle events of the certificates. For example, bootstrap, request, issue, enrolment, revocation, renewal, etc. Thus,
1. Lack of standardization has resulted in a number of customized/proprietary methodologies and varying choices of certificate management protocols resulting in inconsistent model.
2. Once service slicing and non-public network (NPN) are introduced in the service provider network, manual management or lack of standardized procedures for life cycle management of TLS certificates belonging to separate legal entities could further complicate the architecture.

All the above have potential of increasing the security risk and impact the deployment and the availability of operators' 5G SBA network.

To fill the gap in SBA automated certificate management, the chain of trust in SBA architecture should be studied at first. The standardized protocol for managing life cycle can be analyzed only if the chain of trust is confirmed.

Unlike standardized model using Certificate Management Protocol v2 (CMPv2) in wireless networks, SBA does not have a standardized model and chain of trust for automated certificate management. Thus, there are several problems with automated certificate management research in the SBA architecture that require further research.

In some embodiments, at least one of the following needs to be implemented:
1. Establish a chain of trust of certificate authorities hierarchies in the SBA architecture.
2. Issue proper certificates to different 5G Network Functions (NF).
3. Ensure that the 5G NFs are able to verify certificates issued in a same security domain and different security domains.

As shown in FIG. 2, an embodiment provides an authentication method, performed by a first root certificate authority (CA) 22, where the method includes:

Step 21: generating a first-type certificate based on a transport layer security (TLS) protocol.

The first-type certificate is a certificate of an entity 20 in a first security domain in which the first root CA is located.

It should be noted that the entity 20 in the SBA in the present disclosure may be various types of entities, for example, an entity of a fifth generation mobile communication (5G) network or another evolved entity. In some implementations of the present disclosure, the entity may be separately deployed as a communication node, or may be uniformly deployed in an existing network element. In a word, the entity may be understood as a logical node that can be flexibly deployed in a network, which is not limited herein.

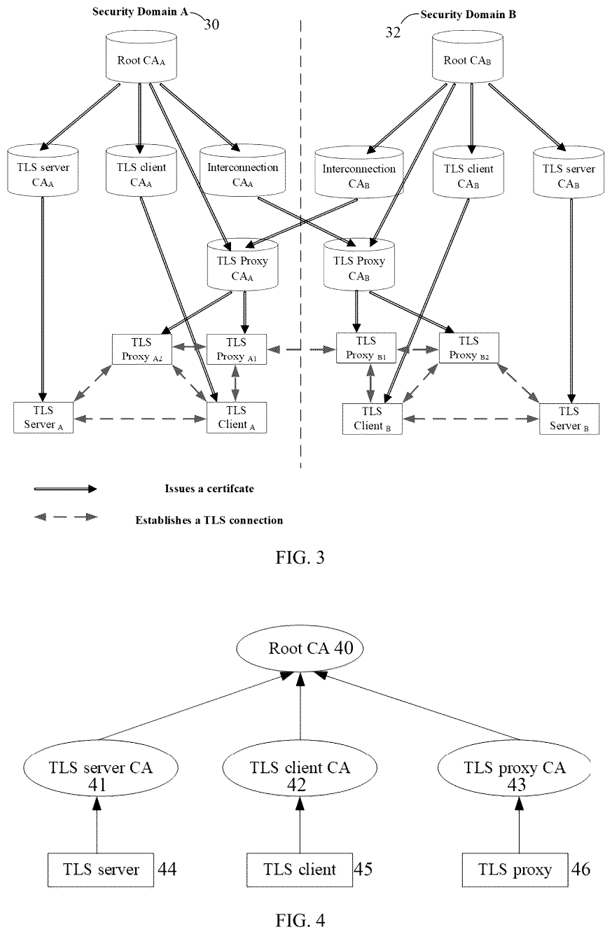

Referring to FIG. 3, a chain of trust of certificate authorities hierarchies in an SBA architecture is shown. There are 2 security domains, which are a security domain A 30 and a security domain B 32, where the security domain A corresponds to the first security domain in step 21, and the security domain B corresponds to a second security domain in step 21. The SBA includes an entity of at least one of:
Root CA_{A};
Root CA_{B};
TLS server CA_{A};
TLS Proxy CA_{A};
TLS client CA_{A};
TLS server CA_{B};
TLS Proxy CA_{B};
TLS client CA_{B};
Interconnection CA_{B};
TLS Proxy _{A2};
TLS Proxy _{A1};
TLS Proxy _{B2};
TLS Proxy _{B1};
TLS Server _{A};
TLS Client _{A};
TLS Server _{B};
TLS Client _{B}.

Solid arrows represent “issues a certificate”; dashed arrows represent “establishes a TLS connection”.

In the embodiments of the present disclosure, the security domain A may also correspond to the second security domain, and the security domain B may also correspond to the first security domain, which is not limited herein. It should be noted that when the first security domain is the security domain A, the first root certificate authority (CA) is the TLS server CA_{A}; and when the first security domain is the security domain B, the first root certificate authority CA is the TLS server CA_{B}. In the embodiments of the present disclosure, a number of security domains may also be greater than 2, for example, 3, which is not limited herein.

Root Certificate Authority (CA) 40: a CA serves as the trust anchor in a chain of trust within a security domain. Each security domain can have only one root CA. The root CA generates a root certificate, where the root certificate is a self-signed certificate. All certificates in this security domain are signed by the root certificate directly or indirectly. It should be noted that the generated first-type certificate may be a root certificate by itself.

TLS Client CA 42: a CA that issues TLS client certificates to TLS clients within a particular operator's security domain.

TLS server CA 41: a CA that issues TLS server certificates to TLS servers within a particular operator's security domain.

TLS Proxy CA 43: a CA that issues TLS proxy certificates to TLS proxies within a particular operator's security domain.

Interconnection CA: a CA that issues cross-certificates to TLS client CAs and TLS server CAs of other domains with which the operator's TLS entities have interconnection.

TLS server 44: TLS terminal entities acting as 5G Network Function (NF) producers. The TLS servers are configured with TLS server certificates issued by the TLS server CA. The NF herein may include an Access Control And Mobility Management Function (AMF), a Session Management Function (SMF), and the like.

TLS client 45: TLS terminal entities acting as 5G NF consumers. The TLS clients are configured with TLS client certificates issued by the TLS client CA. The NF herein may include an Access Control And Mobility Management Function (AMF) and a Session Management Function (SMF).

TLS proxy 46: Network functions (e.g. service communication proxy (SCP), security edge protection proxy (SEPP)) that act as proxy functions in SBA architecture. The TLS proxy may be an intermediate point between the TLS client and the TLS server, or may assist the TLS terminal entity in establishing a TLS connection between the security domains. The TLS entity may verify identity of the TLS proxy by verifying the TLS proxy certificate of the TLS proxy.

It should be noted that, considering that some TLS terminal entities may serve as both NF producers and NF consumers, the TLS terminal entities may need both TLS client certificates and TLS server certificates.

For an intra-security domain TLS connection, the chain of trust is shown in FIG. 4, considering that the TLS server, the TLS client, and the TLS proxy trust a same root CA, the TLS server, the TLS client and the TLS proxy can authenticate each other by verifying TLS entity certificates. The TLS entity certificates herein include the TLS server certificate, the TLS client certificate, and the TLS proxy certificate.

For an inter-security domain TLS connection, the chain of trust is shown in FIG. 5, the inter-security domain TLS connections are mainly established between TLS proxies in different security domains. FIG. 5 shows an inter-domain chain of trust. As shown in FIG. 5, inter-security domain TLS connections are mainly established between TLS proxies in different security domains. FIG. 5 shows an inter-domain chain of trust. As shown in FIG. 5, TLS proxyA trusts TLS proxy CA_{A}, and TLS proxy CA_{A} trusts Interconnection CA_{B}, and Interconnection CA_{B} trusts Root CA_{B}. Considering root CA_{B} is the trust anchor of security domain B, the TLS proxyA trusts TLS entities within the security domain B 51. And vice versa, TLS proxyB trusts TLS proxy CA_{B}, and TLS proxy CA_{B} trusts Interconnection CA_{A}, and Interconnection CA_{A} trusts Root CA_{A}. Considering Root CA_{A} is the trust anchor of security domain A, the TLS proxyB trusts TLS entities within security domain A 50.

In an embodiment, a predetermined certificate based on the transport layer security (TLS) protocol is generated, where the predetermined certificate includes at least one of: the first-type certificate of entities in the first security domain in which the first root CA is located; and a second-type certificate of entities in a second security domain in which a second root CA is located, where the second-type certificate is at least used for TLS verification between entities in the first security domain and the second security domain. The predetermined certificate is sent to the entities.

In an embodiment, generating the certificate in the SBA may include:
1. Generate the first-type certificate for the TLS server, the TLS client or the TLS proxy within the security domain (e.g., the first security domain).

The Root CA generates the first-type certificate of the TLS server CA, the TLS client CA, or the TLS proxy CA that is signed with the root CA's private key. The TLS server CA, the TLS client CA, or the TLS proxy CA generates a third-type certificate of the TLS server, the TLS client, or the TLS proxy that is signed with the intermediate CA's private key. The third-type certificate of the TLS server, the TLS client, or the TLS proxy contains a public key, which can be used to establish TLS tunnels between the TLS entities. The intermediate layer CA herein may be any one of the TLS server CA, the TLS client CA, or the TLS proxy CA.
2. Generate a certificate for inter-domain (inter-first and second security domains) TLS proxy.

The Root CA_{A} generates the certificate of the Interconnection CA_{A} that is signed with the Root CA_{A}'s private key. The Interconnection CA_{A} generates the certificate of the TLS proxy CA_{B} that is signed by the Interconnection CA_{A}'s private key. The TLS proxy CA_{B} generates the certificate of the TLS proxyB that is signed with the TLS proxy CA_{B}'s private key. The TLS proxyB certificate contains a public key, which can be used to establish TLS tunnels between the TLS entities.

In an embodiment, certificates in the SBA may be verified.

Verify certificate in SBA architecture:
1. Verify the TLS certificate between intra-security domain TLS entities.

It is assumed that the TLS client and the TLS server are within the same security domain (e.g., the first security domain) and are pre-configured with the root CA's self-signed certificate (i.e., the root certificate). When the TLS client receives the certificate of the TLS server as part of the TLS handshake, TLS client performs the following procedure.
Step a1: the TLS client checks to ensure that the TLS server's certificate is not expired. Considering that the TLS server's certificate is signed by the TLS server CA, the TLS client tries to get the TLS server CA's certificate. Once the TLS server CA's certificate is obtained, the TLS client uses a public key in the TLS server CA's certificate to verify that the TLS server's certificate is properly signed.
Step a2: the TLS client attempts to verify that whether the TLS server CA's certificate is trusted. Considering that the TLS server CA's certificate is signed by the Root CA, the TLS client uses the public key in the configured self-signed root certificate to verify the signature of the TLS server CA's certificate.
Step a3: the TLS client is locally configured with a self-signed root certificate that the TLS client implicitly trusts, to ensure the public key in the root certificate is trusted. At this point, the TLS client successfully verifies the identity of TLS server, builds the chain of trust to the TLS server, and the intra-domain TLS handshake is accomplished.

Similarly, in a case of two-way authentication, the TLS server may verify the TLS client's certificate, verify the identity of the TLS client, and accomplish the TLS handshake in the security domain.
2. Verify the TLS certificate between inter-security domain TLS proxy.

It is assumed that the TLS proxyA and the TLS proxyB are in different security domains and are pre-configured with their root CA's self-signed certificate (e.g. TLS proxyA is pre-configured with the Root CA_{A}'s self-signed certificate and TLS proxyB is pre-configured with the Root CA_{B}'s self-signed certificate). When the TLS proxyA receives the certificate of the TLS proxyB as part of the SSL/TLS handshake, the TLS proxyA performs the following procedure.

Step b1: The TLS proxyA checks to ensure that the TLS proxyB's certificate is not expired. Considering that the TLS proxyB's certificate is signed by the TLS proxy CA_{B}, the TLS proxyA tries to get the TLS proxy CA_{B}'s certificate. Once the TLS proxy CA_{B}'s certificate is obtained, the TLS proxyA uses the public key in the TLS proxy CA_{B}'s certificate to verify that whether the TLS proxyB's certificate is properly signed.

Step b2: the TLS proxyA attempts to verify that the TLS proxy CA_{B}'s certificate is trusted. Considering that the TLS proxy CA_{B}'s certificate is signed by the Interconnection CA_{A}, the TLS proxyA tries to get the Interconnection CA_{A}'s certificate. Once the Interconnection CA_{A}'s certificate is obtained, the TLS proxy A uses the public key in the Interconnection CA_{A}'s certificate to verify that the TLS proxy CA_{B}'s certificate is properly signed.

Step b3: the TLS proxyA attempts to verify that whether the Interconnection CA_{A}'s certificate is trusted. Considering that the Interconnection CA_{A}'s certificate is signed by the Root CA_{A}, the TLS proxyA uses the public key in the configured self-signed root certificate to verify the signature of the Interconnection CA_{A}'s certificate.

Step b4: the TLS proxyA is locally configured with a self-signed root certificate that the TLS proxy A implicitly trusts, to ensure the public key in the Root CA_{A}'s root certificate is trusted. At this point, the TLS proxyA successfully verifies the identity of TLS proxyB, builds the chain of trust to the TLS proxyB, and the inter-domain SSL or TLS handshake is accomplished.

In the embodiments of the present disclosure, the first-type certificate based on the Transport Layer Security (TLS) protocol is generated, where the first-type certificate is a certificate of entities in a first security domain in which a first root CA is located. In this way, because the first root certificate authority (CA) can generate the first-type certificate, entities in a same security domain can implement authentication between entities based on the first-type certificate. Compared with a situation without intra-domain entity authentication, the authentication mechanism of the wireless communication network is improved, and the authentication reliability of the wireless communication network is improved.

It should be noted that those skilled in the art may understand that the method provided in the embodiments of the present disclosure may be performed separately, or may be performed together with some methods in the embodiments of the present disclosure or some methods in related technologies.

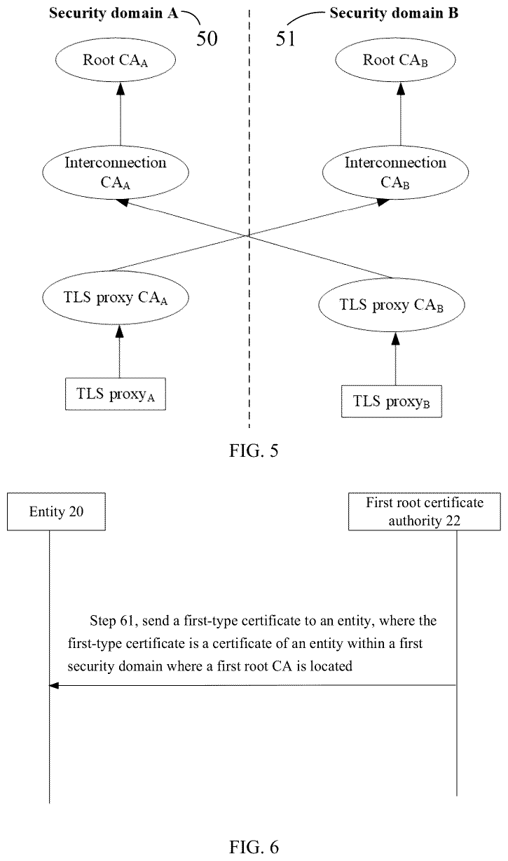

As shown in FIG. 6, an embodiment provides an authentication method, performed by a first root certificate authority (CA), where the method includes:

Step 61: sending a first-type certificate to an entity, where the first-type certificate is a certificate of entity within a first security domain where the first root CA is located.

In the embodiments of the present disclosure, the first-type certificate based on the Transport Layer Security (TLS) protocol is generated and sent to the entity, where the first-type certificate is a certificate of an entity in a first security domain in which a first root CA is located.

In this way, after receiving the first-type certificate, the entity may use the first-type certificate for entity authentication.

It should be noted that those skilled in the art may understand that the method provided in the embodiments of the present disclosure may be performed separately, or may be performed together with some methods in the embodiments of the present disclosure or some methods in related technologies.

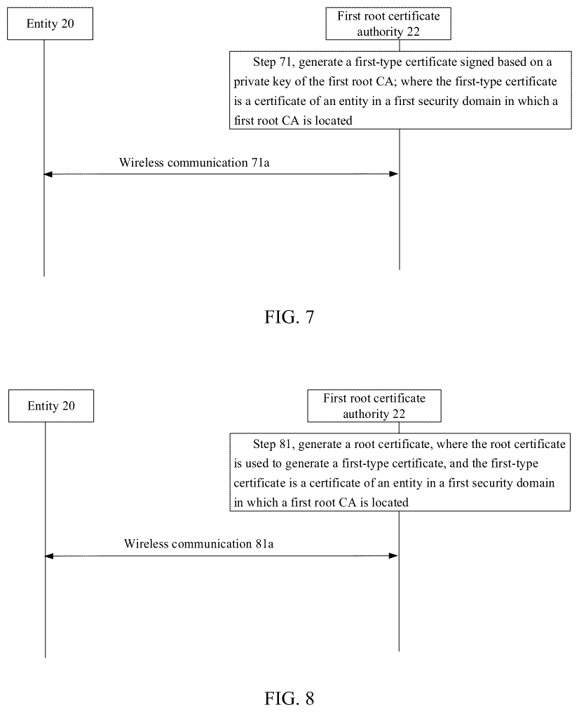

As shown in FIG. 7, an embodiment provides an authentication method, performed by a first root certificate authority (CA), where the method includes:

Step 71: generating a first-type certificate signed based on a private key of the first root CA 22; where the first-type certificate is a certificate of an entity 20 in a first security domain in which the first root CA is located. Wireless communication 71a is indicated.

It should be noted that those skilled in the art may understand that the method provided in the embodiments of the present disclosure may be performed separately, or may be performed together with some methods in the embodiments of the present disclosure or some methods in related technologies.

As shown in FIG. 8, an embodiment provides an authentication method, performed by a first root certificate authority (CA), where the method includes:

Step 81: generating a root certificate, where the root certificate is used to generate a first-type certificate, and the first-type certificate is a certificate of an entity 20 in a first security domain in which the first root CA 22 is located. Wireless communication 81a is indicated.

The first-type certificate may be a certificate of a TLS server CA, a TLS client CA, or a TLS proxy CA.

It should be noted that those skilled in the art may understand that the method provided in the embodiments of the present disclosure may be performed separately, or may be performed together with some methods in the embodiments of the present disclosure or some methods in related technologies.

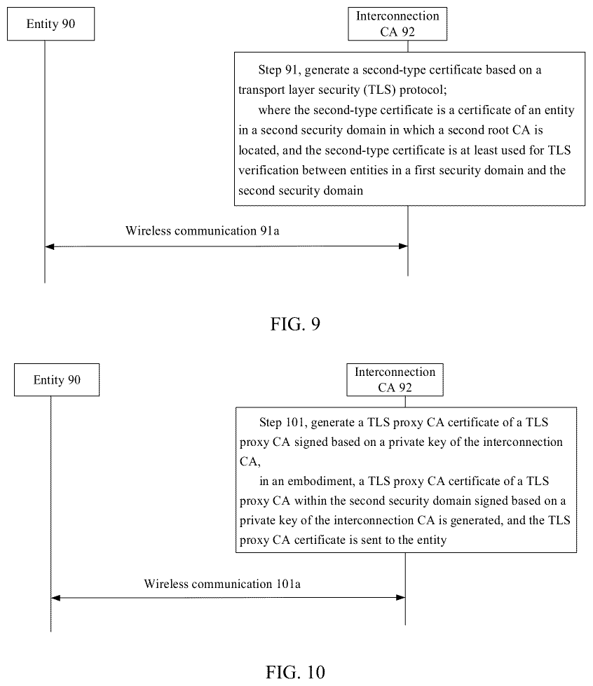

As shown in FIG. 9, an embodiment provides an authentication method, performed by an interconnection CA 92 within a first security domain where the first root CA is located, where the method includes:

Step 91: generating a second-type certificate based on a transport layer security (TLS) protocol. Wireless communication 91a is indicated.

The second-type certificate is a certificate of an entity 90 in a second security domain in which a second root CA is located, and the second-type certificate is at least used for TLS verification between entities in a first security domain and the second security domain.

In an embodiment, the entity includes at least one of:
TLS proxy CA;
TLS proxy;
TLS server; or
TLS client.

In an embodiment, the second-type certificate based on a transport layer security (TLS) protocol is generated, where the second-type certificate is a certificate of an entity in a second security domain in which a second root CA is located, and the second-type certificate is at least used for TLS verification between entities in a first security domain and the second security domain. The second-type certificate is sent to the entity.

In an embodiment, a TLS proxy CA certificate of a TLS proxy CA within the second security domain signed based on a private key of the interconnection CA is generated. The TLS proxy CA certificate is sent to the entity.

It should be noted that those skilled in the art may understand that the method provided in the embodiments of the present disclosure may be performed separately, or may be performed together with some methods in the embodiments of the present disclosure or some methods in related technologies.

As shown in FIG. 10, an embodiment provides an authentication method, performed by an interconnection CA 92 within a first security domain where the first root CA is located, where the method includes:

Step 101: generating a TLS proxy CA certificate of a TLS proxy CA signed based on a private key of the interconnection CA.

In an embodiment, a TLS proxy CA certificate of a TLS proxy CA within the second security domain signed based on a private key of the interconnection CA is generated. The TLS proxy CA certificate is sent to the entity 90. Wireless communication 101a is indicated.

It should be noted that those skilled in the art may understand that the method provided in the embodiments of the present disclosure may be performed separately, or may be performed together with some methods in the embodiments of the present disclosure or some methods in related technologies.

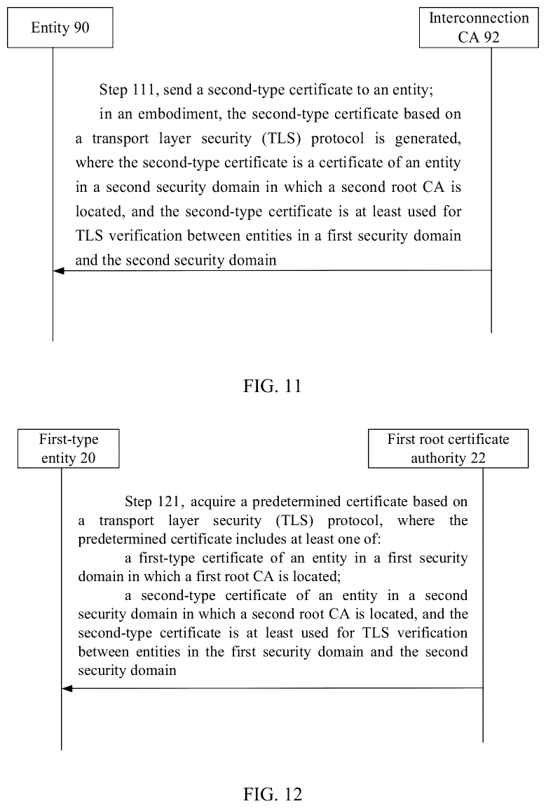

As shown in FIG. 11, an embodiment provides an authentication method, performed by an interconnection CA 92 within a first security domain where the first root CA is located, where the method includes:

Step 111: sending a second-type certificate to an entity 90.

In an embodiment, the second-type certificate based on a transport layer security (TLS) protocol is generated, where the second-type certificate is a certificate of an entity in a second security domain in which a second root CA is located, and the second-type certificate is at least used for TLS verification between entities in a first security domain and the second security domain.

It should be noted that those skilled in the art may understand that the method provided in the embodiments of the present disclosure may be performed separately, or may be performed together with some methods in the embodiments of the present disclosure or some methods in related technologies.

As shown in FIG. 12, an embodiment provides an authentication method, performed by a first-type entity, where the method includes:

Step 121: acquiring a predetermined certificate based on a transport layer security (TLS) protocol, where the predetermined certificate includes at least one of:

a first-type certificate of an entity in a first security domain in which a first root CA is located;

a second-type certificate of an entity in a second security domain in which a second root CA is located, and the second-type certificate is at least used for TLS verification between entities in the first security domain and the second security domain.

In an embodiment, acquiring a predetermined certificate based on a transport layer security (TLS) protocol includes:

acquiring the predetermined certificate that is pre-configured;

or,

receiving the predetermined certificate sent by the first root CA or the interconnection CA.

In an embodiment, the first-type entity includes at least one of:
TLS server CA;
TLS client CA; or
TLS proxy CA.

In an embodiment, the root CA generates the first-type certificate of the TLS server CA, the TLS client CA, or the TLS proxy CA signed with a private key of the root CA, where the first-type certificate is a certificate of an entity in the first security domain in which the first root CA is located. The root CA sends the first-type certificate to the first-type entity. The first-type entity acquires the first-type certificate based on the transport layer security (TLS) protocol. The TLS server CA, the TLS client CA, or the TLS proxy CA generates a third-type certificate of the TLS server, the TLS client, or the TLS proxy that is signed with the intermediate CA's private key. The third-type certificate of the TLS server, the TLS client, or the TLS proxy contains a public key, which can be used to establish TLS tunnels between the TLS entities. The intermediate layer CA herein may be any one of the TLS server CA, the TLS client CA, or the TLS proxy CA.

In an embodiment, the root CA in the first security domain generates an interconnection CA certificate signed with a private key of the root CA, and the interconnection CA in the first security domain generates a second-type certificate based on transport layer security (TLS) protocol, and sends the second-type certificate to the proxy CA in the second security domain.

It should be noted that those skilled in the art may understand that the method provided in the embodiments of the present disclosure may be performed separately, or may be performed together with some methods in the embodiments of the present disclosure or some methods in related technologies.

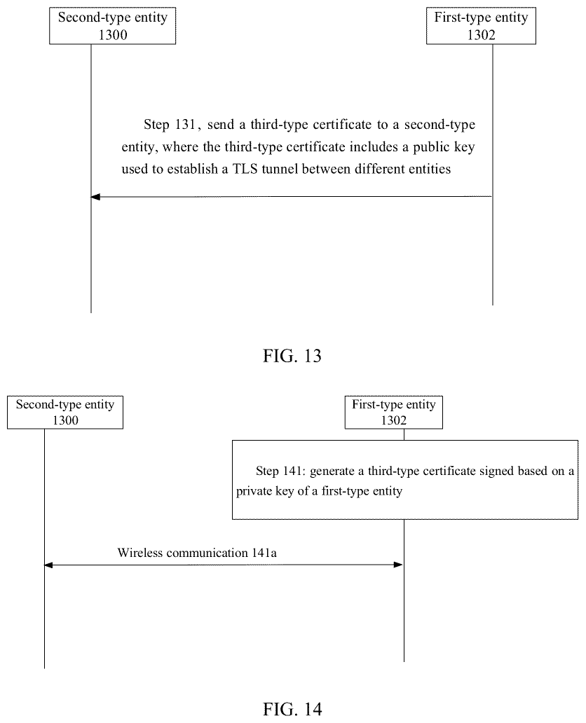

As shown in FIG. 13, an embodiment provides an authentication method, performed by a first-type entity 1302, where the method includes:

Step 131: sending a third-type certificate to a second-type entity 1300, where the third-type certificate includes a public key used to establish a TLS tunnel between different entities.

In an embodiment, the second-type entity includes at least one of:
TLS server;
TLS client; or
TLS proxy.

In an embodiment, the TLS server CA, the TLS client CA, or the TLS proxy CA generates a third-type certificate of the TLS server, the TLS client, or the TLS proxy that is signed with the intermediate CA's private key. The third-type certificate of the TLS server, the TLS client, or the TLS proxy contains a public key, which can be used to establish TLS tunnels between the TLS entities. The intermediate layer CA herein may be any one of the TLS server CA, the TLS client CA, or the TLS proxy CA.

It should be noted that those skilled in the art may understand that the method provided in the embodiments of the present disclosure may be performed separately, or may be performed together with some methods in the embodiments of the present disclosure or some methods in related technologies.

As shown in FIG. 14, an embodiment provides an authentication method, performed by a first-type entity 1302, where the method includes:

Step 141: generating a third-type certificate signed based on a private key of a first-type entity. Wireless communication 141a is indicated

In an embodiment, a third-type certificate signed based on a private key of a first-type entity is generated. The third-type certificate is sent to a second-type entity 1300, where the third-type certificate includes a public key used to establish a TLS tunnel between different entities.

It should be noted that those skilled in the art may understand that the method provided in the embodiments of the present disclosure may be performed separately, or may be performed together with some methods in the embodiments of the present disclosure or some methods in related technologies.

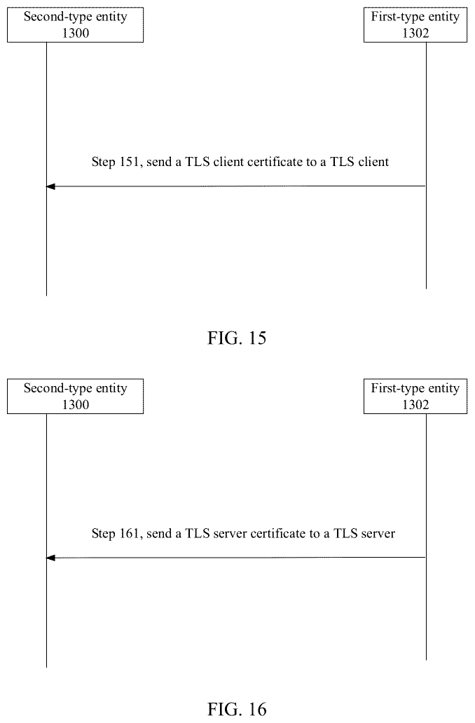

As shown in FIG. 15, an embodiment provides an authentication method, performed by a first-type entity 1302, where the first-type entity includes a TLS client CA, and a second-type entity 1300 includes a TLS client, and the method includes:

Step 151: sending a TLS client certificate to the TLS client.

In an embodiment, the TLS client certificate signed based on a private key of the TLS client CA is generated. The TLS client certificate is sent to the TLS client, where the TLS client certificate includes a public key used to establish a TLS tunnel between different entities.

It should be noted that those skilled in the art may understand that the method provided in the embodiments of the present disclosure may be performed separately, or may be performed together with some methods in the embodiments of the present disclosure or some methods in related technologies.

As shown in FIG. 16, an embodiment provides an authentication method, performed by a first-type entity, where the first-type entity 1302 includes a TLS server CA, and a second-type entity 1300 includes a TLS server, and the method includes:

Step 161: sending a TLS server certificate to the TLS server.

In an embodiment, the TLS server certificate signed based on a private key of the TLS server CA is generated. The TLS server certificate is sent to the TLS server, where the TLS server certificate includes a public key used to establish a TLS tunnel between different entities.

It should be noted that those skilled in the art may understand that the method provided in the embodiments of the present disclosure may be performed separately, or may be performed together with some methods in the embodiments of the present disclosure or some methods in related technologies.

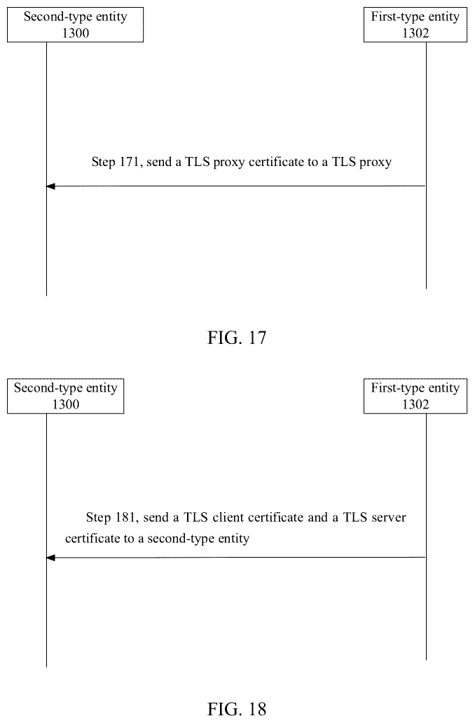

As shown in FIG. 17, an embodiment provides an authentication method, performed by a first-type entity, where the first-type entity 1302 includes a TLS proxy CA, and a second-type entity 1300 includes a TLS proxy, and the method includes:

Step 171: sending a TLS proxy certificate to the TLS proxy.

In an embodiment, the TLS proxy certificate signed with a private key of the TLS proxy CA is generated. The TLS proxy certificate is sent to the TLS proxy, where the TLS proxy certificate includes a public key used to establish a TLS tunnel between different entities.

It should be noted that those skilled in the art may understand that the method provided in the embodiments of the present disclosure may be performed separately, or may be performed together with some methods in the embodiments of the present disclosure or some methods in related technologies.

As shown in FIG. 18, an embodiment provides an authentication method, performed by a first-type entity 1302, where the method includes:

Step 181: sending a TLS client certificate and a TLS server certificate to a second-type entity 1300.

In an embodiment, the TLS client certificate and the TLS server certificate signed with a private key of the first-type entity are generated. The TLS client certificate and the TLS server certificate are sent to the second-type of entity, where the TLS client certificate and the TLS server certificate include public keys for establishing a TLS tunnel between different entities.

It should be noted that those skilled in the art may understand that the method provided in the embodiments of the present disclosure may be performed separately, or may be performed together with some methods in the embodiments of the present disclosure or some methods in related technologies.

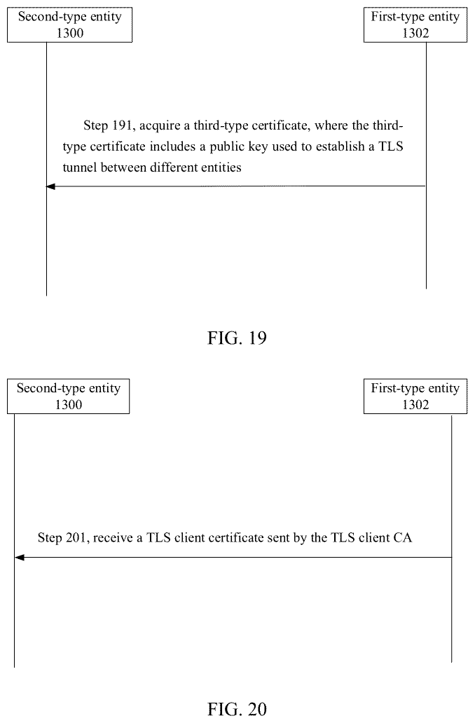

As shown in FIG. 19, an embodiment provides an authentication method, performed by a second-type entity 1300, where the method includes:

Step 191: acquiring a third-type certificate, where the third-type certificate includes a public key used to establish a TLS tunnel between different entities.

In an embodiment, the third-type certificate sent by a first-type entity 1302 is acquired, where the third-type certificate includes a public key used to establish a TLS tunnel between different entities.

In an embodiment, acquiring the third-type certificate includes:

acquiring the third-type certificate that is pre-configured;

or,

receiving the third-type certificate sent by the first-type entity.

In an embodiment, the second-type entity includes at least one of:
TLS server;
TLS client; or
TLS proxy.

In an embodiment, the TLS server CA, the TLS client CA, or the TLS proxy CA generates a corresponding third-type certificate of the TLS server, the TLS client, or the TLS proxy signed with a private key of an intermediate layer CA, where the third-type certificate includes a public key used to establish a TLS tunnel between different entities. The second-type entity acquires the third-type certificate sent by the first-type entity. The third-type certificate of the TLS server, the TLS client, or the TLS proxy contains a public key, which can be used to establish TLS tunnels between the TLS entities. The intermediate layer CA herein may be any one of the TLS server CA, the TLS client CA, or the TLS proxy CA.

It should be noted that those skilled in the art may understand that the method provided in the embodiments of the present disclosure may be performed separately, or may be performed together with some methods in the embodiments of the present disclosure or some methods in related technologies.

As shown in FIG. 20, an embodiment provides an authentication method, performed by a second-type entity, where a first-type entity 1302 includes a TLS client CA, and the second-type entity 1300 includes a TLS client, and the method includes:

Step 201: receiving a TLS client certificate sent by the TLS client CA.

In an embodiment, the TLS client CA generates the TLS client certificate signed based on a private key of the TLS client CA. The TLS client CA sends the TLS client certificate to the TLS client, where the TLS client certificate includes a public key used to establish a TLS tunnel between different entities. The TLS client receives the TLS client certificate sent by the TLS client CA.

It should be noted that those skilled in the art may understand that the method provided in the embodiments of the present disclosure may be performed separately, or may be performed together with some methods in the embodiments of the present disclosure or some methods in related technologies.

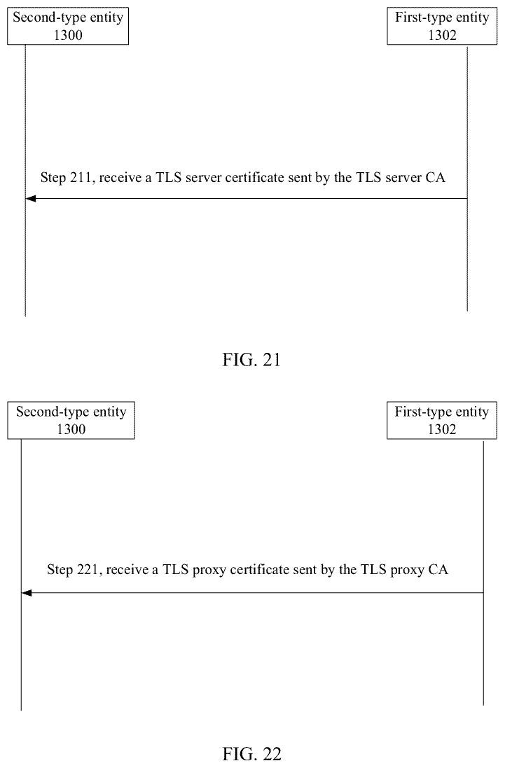

As shown in FIG. 21, an embodiment provides an authentication method, performed by a second-type entity, where a first-type entity 1302 includes a TLS server CA, and the second-type entity 1300 includes a TLS server, and the method includes:

Step 211: receiving a TLS server certificate sent by the TLS server CA.

In an embodiment, the TLS server CA generates the TLS server certificate signed based on a private key of the TLS server CA. The TLS server CA sends the TLS server certificate to the

TLS server, where the TLS server certificate includes a public key used to establish a TLS tunnel between different entities. The TLS server receives the TLS server certificate sent by the TLS server CA.

It should be noted that those skilled in the art may understand that the method provided in the embodiments of the present disclosure may be performed separately, or may be performed together with some methods in the embodiments of the present disclosure or some methods in related technologies.

As shown in FIG. 22, an embodiment provides an authentication method, performed by a second-type entity 1300, where a first-type entity 1302 includes a TLS proxy CA, and the second-type entity includes a TLS proxy, and the method includes:

Step 221: receiving a TLS proxy certificate sent by the TLS proxy CA.

In an embodiment, the TLS proxy CA generates the TLS proxy certificate signed with a private key of the TLS proxy CA. The TLS proxy CA sends the TLS proxy certificate to the TLS proxy, where the TLS proxy certificate includes a public key used to establish a TLS tunnel between different entities. The TLS proxy receives the TLS proxy certificate sent by the TLS proxy CA.

It should be noted that those skilled in the art may understand that the method provided in the embodiments of the present disclosure may be performed separately, or may be performed together with some methods in the embodiments of the present disclosure or some methods in related technologies.

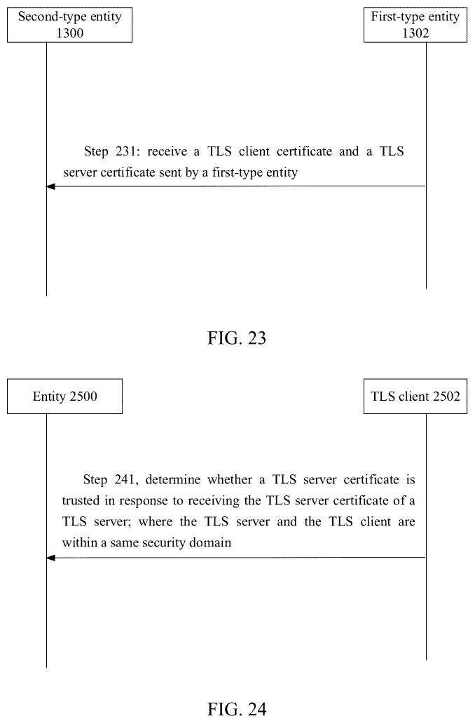

As shown in FIG. 23, an embodiment provides an authentication method, performed by a second-type entity 1300, where the method includes:

Step 231: receiving a TLS client certificate and a TLS server certificate sent by a first-type entity 1302.

In an embodiment, the first-type entity generates the TLS client certificate and the TLS server certificate signed with a private key of the first-type entity. The first-type entity sends the TLS client certificate and the TLS server certificate to the second-type of entity, where the TLS client certificate and the TLS server certificate include public keys for establishing a TLS tunnel between different entities. The second-type entity receives the TLS client certificate and the TLS server certificate sent by the first-type entity.

It should be noted that those skilled in the art may understand that the method provided in the embodiments of the present disclosure may be performed separately, or may be performed together with some methods in the embodiments of the present disclosure or some methods in related technologies.

As shown in FIG. 24, an embodiment provides an authentication method, performed by a TLS client 2502, where the method includes:

Step 241: determining whether a TLS server certificate is trusted in response to receiving the TLS server certificate of a TLS server.

The TLS server and the TLS client are within a same security domain.

In an embodiment, it is assumed that the TLS client and the TLS server are within the same security domain (e.g., the first security domain) and are pre-configured with the root CA's self-signed certificate (i.e., the root certificate). When the TLS client receives the certificate of the TLS server as part of TLS handshake, the TLS client performs following procedure.

Step a1: the TLS client checks to ensure that the TLS server's certificate is not expired. Considering that the TLS server's certificate is signed by the TLS server CA, the TLS client tries to get the TLS server CA's certificate. Once the TLS server CA's certificate is obtained, the TLS client uses a public key in the TLS server CA's certificate to verify that the TLS server's certificate is properly signed.

Step a2: the TLS client attempts to verify that whether the TLS server CA's certificate is trusted. Considering that the TLS server CA's certificate is signed by the Root CA, the TLS client uses the public key in the pre-configured self-signed root certificate to verify the signature of the TLS server CA's certificate.

Step a3: the TLS client is locally configured with a self-signed root certificate that the TLS client implicitly trusts, to ensure the public key in the root certificate is trusted. At this point, the TLS client successfully verifies the identity of TLS server, builds the chain of trust to the TLS server, and the intra-domain TLS handshake is accomplished. It should be noted that those skilled in the art may understand that the method provided in the embodiments of the present disclosure may be performed separately, or may be performed together with some methods in the embodiments of the present disclosure or some methods in related technologies.

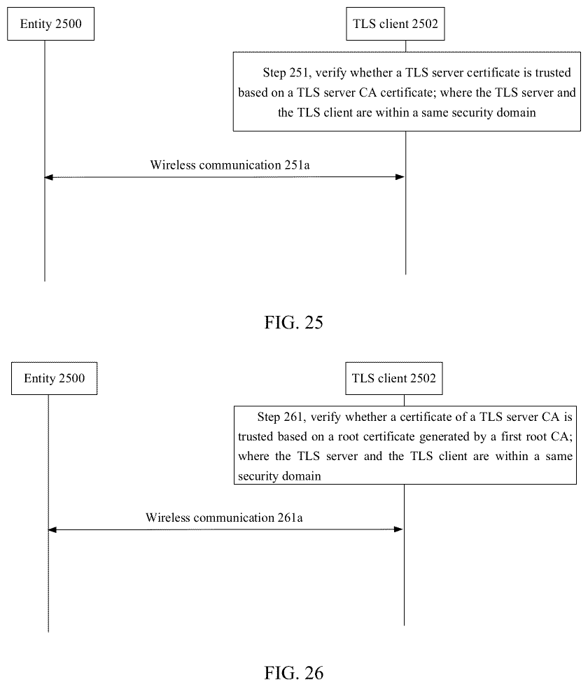

As shown in FIG. 25, an embodiment provides an authentication method, performed by a TLS client 2502, where the method includes:

Step 251: verifying whether a TLS server certificate is trusted based on a TLS server CA certificate. Entity 2500 and wireless communication 251a are indicated.

The TLS server and the TLS client are within a same security domain.

In an embodiment, it is assumed that the TLS client and the TLS server are within the same security domain (e.g., the first security domain) and are pre-configured with the root CA's self-signed certificate (i.e., the root certificate). When the TLS client receives the TLS server certificate as part of TLS handshake, the TLS client performs following procedure: the TLS client checks to ensure that the TLS server certificate is not expired. Considering that the TLS server's certificate is signed by the TLS server CA, the TLS client tries to get the TLS server CA's certificate. Once the TLS server CA's certificate is obtained, the TLS client uses a public key in the TLS server CA's certificate to verify that the TLS server's certificate is properly signed.

It should be noted that those skilled in the art may understand that the method provided in the embodiments of the present disclosure may be performed separately, or may be performed together with some methods in the embodiments of the present disclosure or some methods in related technologies.

As shown in FIG. 26, an embodiment provides an authentication method, performed by a TLS client 2502, where the method includes:

Step 261: verifying whether a certificate of a TLS server CA is trusted based on a root certificate generated by a first root CA. Entity 2500 and wireless communication 261a are indicated.

The TLS server and the TLS client are within a same security domain.

In an embodiment, it is assumed that the TLS client and the TLS server are within the same security domain (e.g., the first security domain) and are pre-configured with the root CA's self-signed certificate (i.e., the root certificate). When the TLS client receives the TLS server certificate as part of TLS handshake, the TLS client performs following procedure: the TLS client attempts to verify whether the certificate of the TLS server CA is trusted. Considering that the TLS server CA's certificate is signed by the Root CA, the TLS client uses the public key in the pre-configured self-signed root certificate to verify the signature of the TLS server CA's certificate.

It should be noted that those skilled in the art may understand that the method provided in the embodiments of the present disclosure may be performed separately, or may be performed together with some methods in the embodiments of the present disclosure or some methods in related technologies.

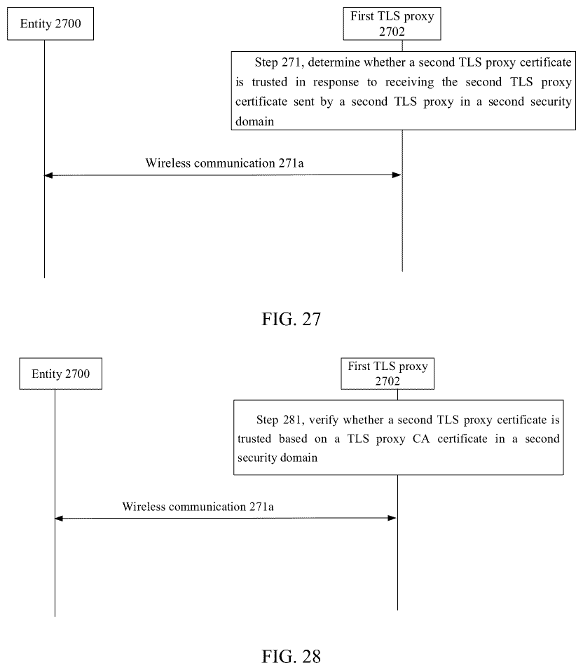

As shown in FIG. 27, an embodiment provides an authentication method, performed by a first TLS proxy 2702 in a first security domain, where the method includes:

Step 271: determining whether a second TLS proxy certificate is trusted in response to receiving the second TLS proxy certificate sent by a second TLS proxy in a second security domain. Entity 2700 and wireless communication 271a are indicated.

In an embodiment, it is assumed that the TLS proxyA and the TLS proxyB are in different security domains and are pre-configured with their root CA's self-signed certificate (e.g. TLS proxyA is pre-configured with the Root CA_{A}'s self-signed certificate and TLS proxyB is pre-configured with the Root CA_{B}'s self-signed certificate). When the TLS proxyA receives the certificate of the TLS proxyB as part of the SSL/TLS handshake, the TLS proxyA performs the following procedure.

Step b1: the TLS proxyA checks to ensure that the TLS proxyB's certificate is not expired. Considering that the TLS proxyB's certificate is signed by the TLS proxy CA_{B}, the TLS proxyA tries to get the TLS proxy CA_{B}'s certificate. Once the TLS proxy CA_{B}'s certificate is obtained, the TLS proxyA uses the public key in the TLS proxy CA_{B}'s certificate to verify that whether the TLS proxyB's certificate is properly signed.

Step b2: the TLS proxyA attempts to verify that the TLS proxy CA_{B}'s certificate is trusted. Considering that the TLS proxy CA_{B}'s certificate is signed by the Interconnection CA_{A}, the TLS proxy A tries to get the Interconnection CA_{A}'s certificate. Once the Interconnection CA_{A}'s certificate is obtained, the TLS proxyA uses the public key in the Interconnection CA_{A}'s certificate to verify that the TLS proxy CA_{B}'s certificate is properly signed.

Step b3: the TLS proxyA attempts to verify that whether the Interconnection CA_{A}'s certificate is trusted. Considering that the Interconnection CA_{A}'s certificate is signed by the Root CA_{A}, the TLS proxyA uses the public key in the configured self-signed root certificate to verify the signature of the Interconnection CA_{A}'s certificate.

Step b4: the TLS proxyA is locally configured with a self-signed root certificate that the TLS proxyA implicitly trusts, to ensure the public key in the Root CA_{A}'s root certificate is trusted. At this point, the TLS proxyA successfully verifies the identity of TLS proxyB, builds the chain of trust to the TLS proxyB, and the inter-domain SSL or TLS handshake is accomplished.

It should be noted that those skilled in the art may understand that the method provided in the embodiments of the present disclosure may be performed separately, or may be performed together with some methods in the embodiments of the present disclosure or some methods in related technologies.

As shown in FIG. 28, an embodiment provides an authentication method, performed by a first TLS proxy 2702 in a first security domain, where the method includes:

Step 281: verifying whether a second TLS proxy certificate is trusted based on a TLS proxy CA certificate in a second security domain. Entity 2700 and wireless communication 271a are indicated.

In an embodiment, it is assumed that the TLS proxyA and the TLS proxyB are in different security domains and are pre-configured with their root CA's self-signed certificate (e.g. TLS proxy A is pre-configured with the Root CA_{A}'s self-signed certificate and TLS proxyB is pre-configured with the Root CA_{B}'s self-signed certificate). When the TLS proxyA receives the TLS proxyB's certificate as part of SSL or TLS handshake, the TLS proxyA performs the following procedure: the TLS proxyA checks to ensure that the TLS proxyB's certificate is not expired. Considering that the TLS proxyB's certificate is signed by the TLS proxy CA_{B}, the TLS proxyA tries to get the TLS proxy CA_{B}'s certificate. Once the TLS proxy CA_{B}'s certificate is obtained, the TLS proxyA uses the public key in the TLS proxy CA_{B}'s certificate to verify that whether the TLS proxyB's certificate is properly signed.

It should be noted that those skilled in the art may understand that the method provided in the embodiments of the present disclosure may be performed separately, or may be performed together with some methods in the embodiments of the present disclosure or some methods in related technologies.

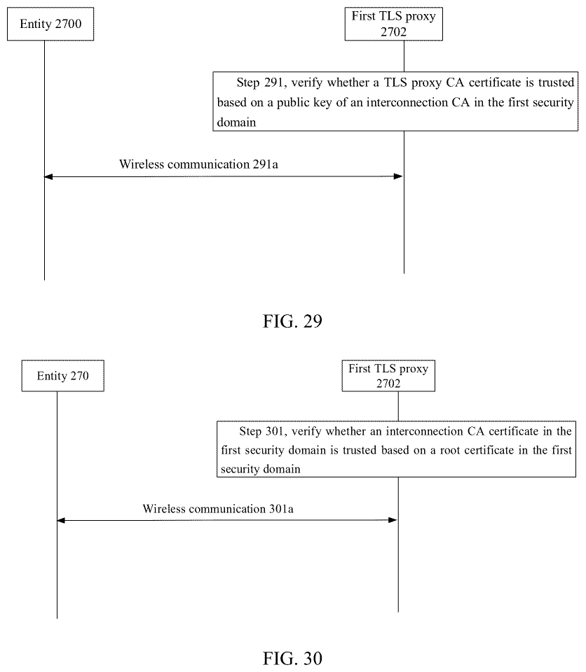

As shown in FIG. 29, an embodiment provides an authentication method, performed by a first TLS proxy 2702 in a first security domain, where the method includes:

Step 291: verifying whether a TLS proxy CA certificate is trusted based on a public key of an interconnection CA in the first security domain. Entity 2700 and wireless communication 291a are indicated.

In an embodiment, it is assumed that the TLS proxyA and the TLS proxyB are in different security domains and are pre-configured with their root CA's self-signed certificate (e.g. TLS proxyA is pre-configured with the Root CA_{A}'s self-signed certificate and TLS proxyB is pre-configured with the Root CA_{B}'s self-signed certificate). When the TLS proxyA receives the TLS proxyB's certificate as part of SSL or TLS handshake, the TLS proxyA performs the following procedure: the TLS proxyA attempts to verify whether the TLS proxy CA_{B}'s certificate is trusted. Considering that the TLS proxy CA_{B}'s certificate is signed by the Interconnection CA_{A}, the TLS proxyA tries to get the Interconnection CA_{A}'s certificate. Once the Interconnection CA_{A}'S certificate is obtained, the TLS proxyA uses the public key in the Interconnection CA_{A}'s certificate to verify that the TLS proxy CA_{B}'s certificate is properly signed.

It should be noted that those skilled in the art may understand that the method provided in the embodiments of the present disclosure may be performed separately, or may be performed together with some methods in the embodiments of the present disclosure or some methods in related technologies.

As shown in FIG. 30, an embodiment provides an authentication method, performed by

a first TLS proxy 2702 in a first security domain, where the method includes:

Step 301: verifying whether an interconnection CA certificate in the first security domain is trusted based on a root certificate in the first security domain. Entity 2700 and wireless communication 311a are indicated.

In an embodiment, it is assumed that the TLS proxyA and the TLS proxyB are in different security domains and are pre-configured with their root CA's self-signed certificate (e.g. TLS proxy A is pre-configured with the Root CA_{A}'s self-signed certificate and TLS proxyB is pre-configured with the Root CA_{B}'s self-signed certificate). When the TLS proxyA receives the TLS proxyB's certificate as part of SSL or TLS handshake, the TLS proxyA performs the following procedure: the TLS proxyA attempts to verify whether the Interconnection CA_{A}'s certificate is trusted. Considering that the Interconnection CA_{A}'s certificate is signed by the Root CA_{A}, the TLS proxy A uses the public key in the configured self-signed root certificate to verify the signature of the Interconnection CA_{A}'s certificate.

It should be noted that those skilled in the art may understand that the method provided in the embodiments of the present disclosure may be performed separately, or may be performed together with some methods in the embodiments of the present disclosure or some methods in related technologies.

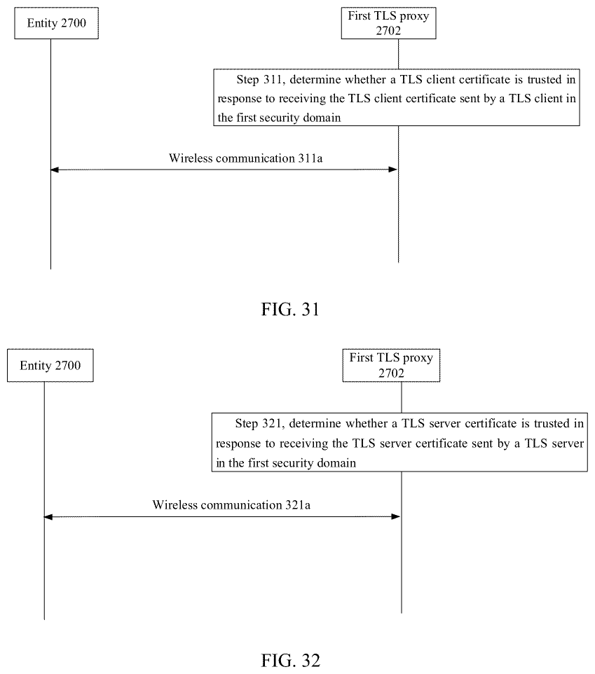

As shown in FIG. 31, an embodiment provides an authentication method, performed by a first TLS proxy 2702 in a first security domain, where the method includes:

Step 311: determining whether a TLS client certificate is trusted in response to receiving the TLS client certificate sent by a TLS client in the first security domain. Entity 2700 and wireless communication 311a are indicated.

In an embodiment, determining whether the TLS client certificate is trusted includes:

verifying whether the TLS client certificate is trusted based on a TLS client CA certificate in the first security domain.

In an embodiment, the method further includes:

verifying whether the TLS client CA certificate is trusted based on a public key of a root certificate in the first security domain.

It should be noted that, for descriptions related to step 311 can be referred from descriptions of step 271 to step 301, and the verification process is similar, which will not be repeated herein.

It should be noted that those skilled in the art may understand that the method provided in the embodiments of the present disclosure may be performed separately, or may be performed together with some methods in the embodiments of the present disclosure or some methods in related technologies.

As shown in FIG. 32, an embodiment provides an authentication method, performed by a first TLS proxy 2700 in a first security domain, where the method includes:

Step 321: determining whether a TLS server certificate is trusted in response to receiving the TLS server certificate sent by a TLS server in the first security domain. Entity 2700 and wireless communication 321a are indicated.

In an embodiment, determining whether the TLS server certificate is trusted includes:

verifying whether the TLS server certificate is trusted based on a TLS server CA certificate in the first security domain.

In an embodiment, the method further includes:

verifying whether the TLS server CA certificate is trusted based on a root certificate in the first security domain.

It should be noted that, for descriptions related to step 321 can be referred from descriptions of step 271 to step 301, and the verification process is similar, which will not be repeated herein.

It should be noted that those skilled in the art may understand that the method provided in the embodiments of the present disclosure may be performed separately, or may be performed together with some methods in the embodiments of the present disclosure or some methods in related technologies.

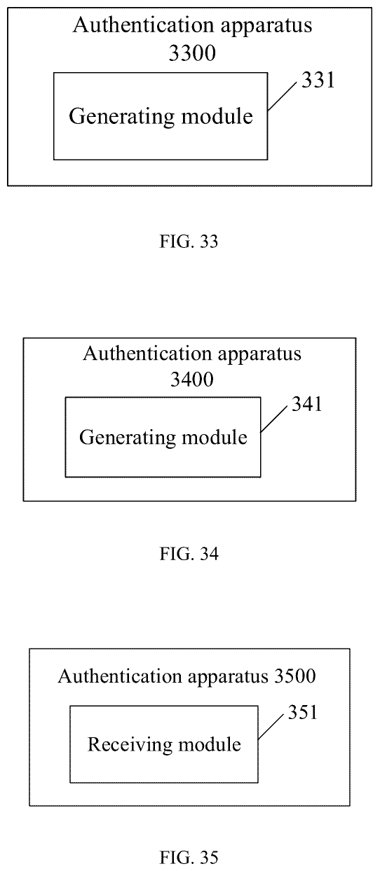

As shown in FIG. 33, an embodiment provides an authentication apparatus 3300, where the apparatus includes:

a generating module 331, configured to generate a first-type certificate based on a transport layer security (TLS) protocol;

where the first-type certificate is a certificate of an entity in a first security domain in which the first root CA is located.

It should be noted that those skilled in the art may understand that the method provided in the embodiments of the present disclosure may be performed separately, or may be performed together with some methods in the embodiments of the present disclosure or some methods in related technologies.

As shown in FIG. 34, an embodiment provides an authentication apparatus 3400, where the apparatus includes:

a generating module 341, configured to generate a second-type certificate based on a transport layer security (TLS) protocol;

where the second-type certificate is a certificate of an entity in a second security domain in which a second root CA is located, and the second-type certificate is at least used for TLS verification between entities in the first security domain and the second security domain.

It should be noted that those skilled in the art may understand that the method provided in the embodiments of the present disclosure may be performed separately, or may be performed together with some methods in the embodiments of the present disclosure or some methods in related technologies.

As shown in FIG. 35, an embodiment provides an authentication apparatus 3500, where the apparatus includes:

a receiving module 351, configured to acquire a first-type certificate based on a transport layer security (TLS) protocol, where the first-type certificate is a certificate of an entity in a first security domain in which a first root certificate authority (CA) is located.

It should be noted that those skilled in the art may understand that the method provided in the embodiments of the present disclosure may be performed separately, or may be performed together with some methods in the embodiments of the present disclosure or some methods in related technologies.

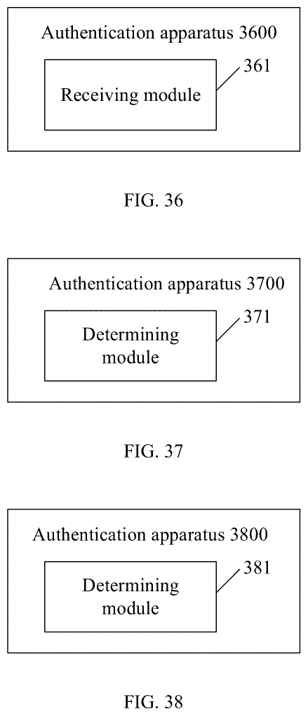

As shown in FIG. 36, an embodiment provides an authentication apparatus 3600, where the apparatus includes:

a receiving module 361, configured to acquire a third-type certificate, where the third-type certificate includes a public key used to establish a transport layer security (TLS) tunnel between different entities.

It should be noted that those skilled in the art may understand that the method provided in the embodiments of the present disclosure may be performed separately, or may be performed together with some methods in the embodiments of the present disclosure or some methods in related technologies.

As shown in FIG. 37, an embodiment provides an authentication apparatus 3700, where the apparatus includes:

a determining module 371, configured to determine whether a transport layer security (TLS) server certificate is trusted in response to receiving the TLS server certificate of a TLS server;

where the TLS server and a TLS client are within a same security domain.

It should be noted that those skilled in the art may understand that the method provided in the embodiments of the present disclosure may be performed separately, or may be performed together with some methods in the embodiments of the present disclosure or some methods in related technologies.

As shown in FIG. 38, an embodiment provides an authentication apparatus 3800, where the apparatus includes:

a determining module 381, configured to determine whether a second transport layer security (TLS) proxy certificate is trusted in response to receiving the second TLS proxy certificate sent by a second TLS proxy in a second security domain.

It should be noted that those skilled in the art may understand that the method provided in the embodiments of the present disclosure may be performed separately, or may be performed together with some methods in the embodiments of the present disclosure or some methods in related technologies.

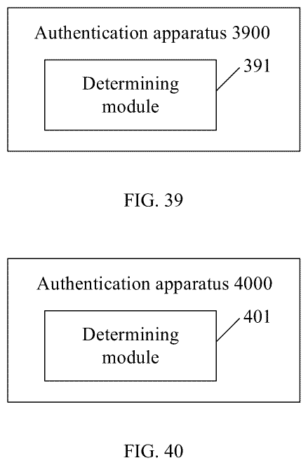

As shown in FIG. 39, an embodiment provides an authentication apparatus 3900, where the apparatus includes:

a determining module 391, configured to determine whether a transport layer security (TLS) client certificate is trusted in response to receiving the TLS client certificate sent by a TLS client in a first security domain.

It should be noted that those skilled in the art may understand that the method provided in the embodiments of the present disclosure may be performed separately, or may be performed together with some methods in the embodiments of the present disclosure or some methods in related technologies.

As shown in FIG. 40, an embodiment provides an authentication apparatus 4000, where the apparatus includes:

a determining module 401, configured to determine whether a transport layer security (TLS) server certificate is trusted in response to receiving the TLS server certificate sent by a TLS server in a first security domain.

It should be noted that those skilled in the art may understand that the method provided in the embodiments of the present disclosure may be performed separately, or may be performed together with some methods in the embodiments of the present disclosure or some methods in related technologies.

An embodiment of the present disclosure provides a communication device, including:

a processor; and

a memory for storing a processor-executable instruction;

the processor is configured to execute the executable instruction to implement the method applied to any one embodiment of the present disclosure.

The processor may include various types of storage medium, the storage media are non-transitory computer storage medium, and can continue to remember information stored thereon after the communication device is powered down.

The processor may be connected to the memory by using a bus or the like, and is configured to read an executable-program stored in the memory.

An embodiment of the present disclosure further provides a computer storage medium, where the computer storage medium stores a computer-executable program, and when the executable program is executed by a processor, the method of any one embodiment of the present disclosure is implemented.

Regarding the apparatus in the above embodiments, the specific manner in which each module performs an operation has been described in detail in the embodiments related to the method, and will not be described in detail herein.

As shown in FIG. 41, an embodiment of the present disclosure provides a structure of a terminal.

Referring to the terminal 800 shown in FIG. 41, this embodiment provides a terminal 800, where the terminal may be specifically a mobile phone, a computer, a digital broadcast terminal, a messaging device, a game console, a tablet device, a medical device, fitness equipment, a personal digital assistant, or the like.

Referring to FIG. 41, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls overall operations of the terminal 800, such as operations associated with display, telephone calls, data communications, camera operations, and recording operations. The processing component 802 may include one or more processors 820 to execute instructions to perform all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the device 800. Examples of such data include instructions for any application or method operating on the terminal 800, contact data, phonebook data, messages, pictures, videos, and the like. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 806 provides power for various components of the terminal 800. The power component 806 may include a power management system, one or more power sources, and other components associated with generating, managing, and distributing power for the terminal 800.

The multimedia component 808 includes a screen providing an output interface between the terminal 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 808 includes a front camera and/or a rear camera. When the device 800 is in an operation mode, such as a photographing mode or a video mode, the front camera and/or the rear camera may receive external multimedia data. Each of the front camera and the rear camera may be a fixed optical lens system or have focal length and optical zoom capability.

The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and peripheral interface modules, which may be keyboards, click wheels, buttons, etc. These buttons may include, but are not limited to, home buttons, volume buttons, start buttons, and lock buttons.

The sensor component 814 includes one or more sensors for providing status assessments of various aspects of the terminal 800. For example, the sensor component 814 may detect an open/closed state of the device 800, relative positioning of components, for example, a display and a keypad of the terminal 800, a position change of the terminal 800 or a component of the terminal 800, a presence or absence of user contact with the terminal 800, an orientation or acceleration/deceleration of the terminal 800, and a temperature change of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as Wi-Fi, 2G, or 3G, or a combination thereof. In an example embodiment, the communication component 816 receives a broadcast signal or broadcast related information from an external broadcast management system via a broadcast channel. In an example embodiment, the communication component 816 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example embodiment, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform the foregoing methods.

In an example embodiment, a non-transitory computer-readable storage medium including instructions is further provided, for example, the memory 804 including instructions, where the instructions may be executed by the processor 820 of the terminal 800 to perform the foregoing method. For example, a non-transitory computer-readable storage medium may be a ROM, random access memory (RAM), CD-ROM, magnetic tape, floppy disk, optical data storage device, and the like.

As shown in FIG. 42, an embodiment of the present disclosure shows a structure of a base station. For example, the base station 900 may be provided as a network-side device. Referring to FIG. 42, the base station 900 includes a processing component 922, which further includes one or more processors, and a memory resource represented by a memory 932 for storing instructions executable by the processing component 922, such as an application program. The application program stored in the memory 932 may include one or more modules each corresponding to a set of instructions. In addition, the processing component 922 is configured to execute instructions to perform any of the foregoing methods applied to the base station.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™, or the like.

Other embodiments of the present disclosure will be readily apparent to those skilled in the art upon consideration of the specification and practice of the present disclosure disclosed herein. The present disclosure is intended to cover any variations, uses, or adaptations of the invention that follow the general principles of the present disclosure and include common knowledge or conventional technical means in the art not disclosed in the present disclosure. The specification and examples are to be regarded as examples only, and the true scope and spirit of the present disclosure are indicated by the following claims.

It should be understood that the present disclosure is not limited to the precise structure already described above and shown in the drawings, and that various modifications and changes may be made without departing from the scope thereof. The scope of the present disclosure is limited only by the appended claims.

1. An authentication method, performed by a first root certificate authority (CA), wherein the method comprises:
generating a first-type certificate based on a transport layer security (TLS) protocol;
wherein the first-type certificate is a certificate of an entity in a first security domain in which the first root CA is located.

2. The method according to claim 1, further comprising:
sending the first-type certificate to the entity.

3. The method according to claim 1, wherein generating the first-type certificate based on the transport layer security (TLS) protocol comprises:
generating the first-type certificate signed based on a private key of the first root CA; or
generating a root certificate, wherein the root certificate is used to generate the first-type certificate.

4. (canceled)

5. The method according to claim 1, wherein the entity comprises at least one of:
Root CA;
TLS server CA;
TLS client CA;
TLS proxy CA;
Interconnection CA;
TLS server;
TLS client; or
TLS proxy.

6. An authentication method, performed by an interconnection certificate authority (CA) in a first security domain in which a first root CA is located, wherein the method comprises:
generating a second-type certificate based on a transport layer security (TLS) protocol;
wherein the second-type certificate is a certificate of an entity in a second security domain in which a second root CA is located, and the second-type certificate is at least used for TLS verification between entities in the first security domain and the second security domain.

7. The method according to claim 6, wherein the entity comprises at least one of:
TLS proxy CA;
TLS proxy;
TLS server; or
TLS client.

8. The method according to claim 6, wherein generating the second-type certificate based on the transport layer security (TLS) protocol comprises:
generating a TLS proxy CA certificate of a TLS proxy CA signed based on a private key of the interconnection CA.

9. The method according to claim 6, further comprising:
sending the second-type certificate to the entity.

10. An authentication method, performed by a first-type entity in a first security domain in which a first root certificate authority (CA) is located, wherein the method comprises:
acquiring a predetermined certificate based on a transport layer security (TLS) protocol,
wherein the predetermined certificate comprises at least one of:
a first-type certificate of an entity in the first security domain in which the first root CA is located; or
a second-type certificate of an entity in a second security domain in which a second root CA is located, and the second-type certificate is at least used for TLS verification between entities in the first security domain and the second security domain.

11. The method according to claim 10, wherein acquiring the predetermined certificate based on the transport layer security (TLS) protocol comprises:
acquiring the predetermined certificate that is pre-configured;
or,
receiving the predetermined certificate sent by the first root CA or an interconnection CA.

12. The method according to claim 10, wherein the first-type entity comprises at least one of:
TLS server CA;
TLS client CA; or
TLS proxy CA.

13. The method according to claim 10, further comprising:
generating a third-type certificate signed based on a private key of the first-type entity.

14. The method according to claim 10, further comprising:
sending a third-type certificate to a second-type entity, wherein the third-type certificate comprises a public key used to establish a TLS tunnel between different entities.

15. The method according to claim 14, wherein the first-type entity comprises a TLS client CA; the second-type entity comprises a TLS client; and sending the third-type certificate to the second-type entity comprises:
sending a TLS client certificate to the TLS client; or
wherein the first-type entity comprises a TLS server CA; the second-type entity comprises a TLS server; and sending the third-type certificate to the second-type entity comprises:
sending a TLS server certificate to the TLS server; or
wherein the first-type entity comprises a TLS proxy CA; the second-type entity comprises a TLS proxy; and sending the third-type certificate to the second-type entity comprises:
sending a TLS proxy certificate to the TLS proxy.

16-17. (canceled)

18. The method according to claim 10, wherein sending the third-type certificate to the second-type entity comprises:
sending a TLS client certificate and a TLS server certificate to the second-type entity.

19. The method according to claim 10, wherein the second-type entity comprises at least one of:
TLS server;
TLS client; or
TLS proxy.

20-48. (canceled)

49. A communication device, comprising:
a memory; and
a processor, connected to the memory, and configured to execute a computer-executable instruction stored on the memory and implement the method according to of claim 1.

50. A non-transitory computer storage medium storing a computer-executable instruction, wherein when the computer-executable instruction is executed by a processor, the method according to claim 1.

51. A communication device, comprising:
a memory; and
a processor, connected to the memory, and configured to execute a computer-executable instruction stored on the memory and implement the method according to claim 6.

52. A communication device, comprising:
a memory; and
a processor, connected to the memory, and configured to execute a computer-executable instruction stored on the memory and implement the method according to claim 10.
